(19) United States
(12) Patent Application Publication
(10) Pub. No.: US 2015/0340905 A1
(43) Pub. Date: Nov. 26, 2015

(54) SUN VISOR WITH WIRELESS CHARGING FUNCTION

(71) Applicant: Chou-Wan Chen, Dong-Guan City (CH)

(72) Inventor: Chou-Wan Chen, Dong-Guan City (CH)

(73) Assignee: DongGuan Evervictory Electronic Co., Ltd, Dong-Guan City (CH)

(21) Appl. No.: 14/489,498

(22) Filed: Sep. 18, 2014

(30) Foreign Application Priority Data
May 20, 2014 (CH) 201420260083.3

(51) Int. Cl. H02J 7/02; H02J 7/00

(52) U.S. Cl. CPC H02J 7/025; H02J 7/0044

(57) ABSTRACT

The present invention provices a sun visor with wireless charging function, which comprises a sun visor body having a charger stand therein; a wireless charging circuit module disposed inside the sun visor body, said wireless charging circuit module including a coil coupled to the charger stand; wherein said charger stand comprises a case and a cover mounted on said case, wherein the case includes a containing space having washers therein. The charger stand has the washers to fix effectively the electronic products to prevent bump on the road, and limits to the position of the electronic products with the positioning convex piece, so as to ensure good connection between the coil of the wireless charging module and the electronic product.

### FIELD OF THE INVENTION

The present invention relates to a wireless charging technical field, particularly to a sun visor with wireless charging.

### BACKGROUND OF THE INVENTION

The wireless charging function uses an electromagnetic field to transfer energy between two objects. Energy is sent through an inductive coupling to an electrical device, which can then use that energy to charge batteries or run the device. Induction chargers typically use an induction coil to create an alternating electromagnetic field from within a charging base station, and a second induction coil in the portable device takes power from the electromagnetic field and converts it back into electrical current to charge the battery. The two induction coils in proximity combine to form an electrical transformer. At present, the wireless charging function has been broadly applied to power supply for mobile phones and portable computers.

A car charger includes a power connector [USB or cigarette lighter] and a connecting line, the power interface usually arranged below a console near the shift lever. Therefore, the connecting line may get entangled in the shift lever when driving the car, which is dangerous for drivers.

Besides, it is inconvenient for mobile phones to charge with a line; therefore, some cars may provide wireless power transmission module, which facilitates charging battery in cars. If the charging mobile phones are unstable in the car, the mobile phone may be separated from transmission base to affect the charging effects.

Moreover, although current car sun visor structures are more common, the functions are merely for sunshade or equipment with a vanity mirror.

### SUMMARY OF INVENTION

Therefore, it is necessary to overcomes the defects of the prior art and provides a multifunctional sun visor with a wireless charging function that can realize wireless charging battery for electronic products, so the car interior space is roomily neat.

The technical problem to be solved by the utility model is to overcome defects of the prior art, which is a sun visor with a wireless charging function comprising

a sun visor body (100) having a charger stand (200) therein; a wireless charging circuit module (110) disposed inside the sun visor body (100), said wireless charging circuit module (110) including a coil (111) coupled to the charger stand (200); wherein said charger stand (200) comprises a case (210) and a cover (220) mounted on said case (210), wherein the case (210) includes a containing space (211) having washers (212) therein.

In one of embodiments, wherein said cover (220) is disposed right above the case (210), and a pivotal connection between the case (210) and the cover (220) is provided with an elastic arm (215); the cover (220) coupled to the elastic arm (215) at which a rotation axis (221) is arranged and is stuck within the elastic arm (215), the cover (220) revolved around the elastic arm (215) via the rotation axis (221).

In one of embociments, wherein one end of pivotal connection between the cover (220) and the case (210) is provided with a positioning convex piece (224).

In one of embodiments, wherein one end of a side wall of the case (210) is provided with a concave part (213), and the case (210) disposed two side of said concave part is provided with fastener slots (214); wherein the cover (220) coupled to the fastener slots (214) at which fasteners (222) are disposed, the fasteners (222) are disposed inside the fastener slots (214).

In one of embodiments, wherein a central part of the cover (220) includes a transparent window (223).

In one of embodiments, wherein the washers (212) are elastic sucker structures.

In one of embodiments, wherein the washers (212) are spaced on a bottom wall of the containing space (211).

In one of embodiments, wherein the sun visor body (100) is further provided with a power interface (120) which is electrically connected with the wireless charging circuit module (110).

In one of embodiments, wherein the sun visor body (100) is further provided with a bluetooth module (130) for connecting with electronic products through bluetooth, a radio frequency module (140) for transmitting audio signal from an electronic product to a vehicle host, and a microphone (150) being electrically connected with the bluetooth module (130), used for transmitting signal to electronic product through the bluetooth module (130) to realize communication function.

In one of embodiments, wherein the sun visor body (100) positioned in one side of the charger stand (200) includes a keypad module (160); the keypad module (160) electrically connected with the bluetooth module (130) and controlled the electronic product through the bluetooth module (130).

Of these, the sun visor with wireless charging function of the present invention is provided with a charger stand (200) in the sun visor body (100), which uses the washers (212) to fix effectively the electronic products to prevent bump on the road, and limits to the position of the electronic products with the positioning convex piece (224), so as to ensure good connection between the coil (111) of the wireless charging module (110) and the electronic product, besices, when the cover (220) covered on the case (210), it will have more stability for the electronic product, so as to prevent it from shake in the containing space (211) when driving in the bumpy road.

### BRIEF DESCRIPTION OF THE DRAWINGS

FIG. 1 is a structural schematic view of a sun visor with wireless charging function of the present invention;

FIG. 2 is a structural schematic view of a charging stand of a sun visor with wireless charging function of the present invention;

FIG. 3 is a structural schematic view showing a charger stand installed with a wireless charging circuit module according to the present invention;

FIG. 4 is a structural schematic view showing a sun visor with wireless charging function concealed partial case according to the present invention.

### DETAILED DESCRIPTION OF THE PREFERRED EMBODIMENTS

The invention will now be described in connection with certain preferred embodiments with reference to the following illustrative figures so that it may be more fully understood.

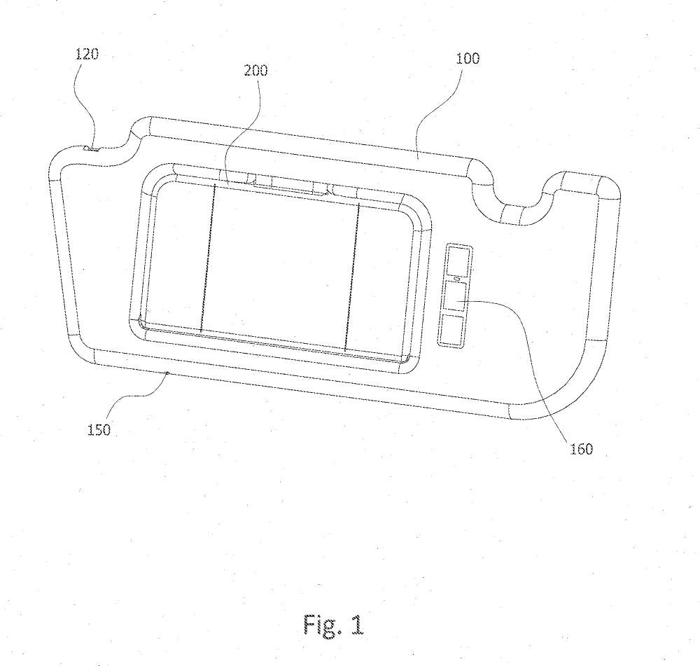

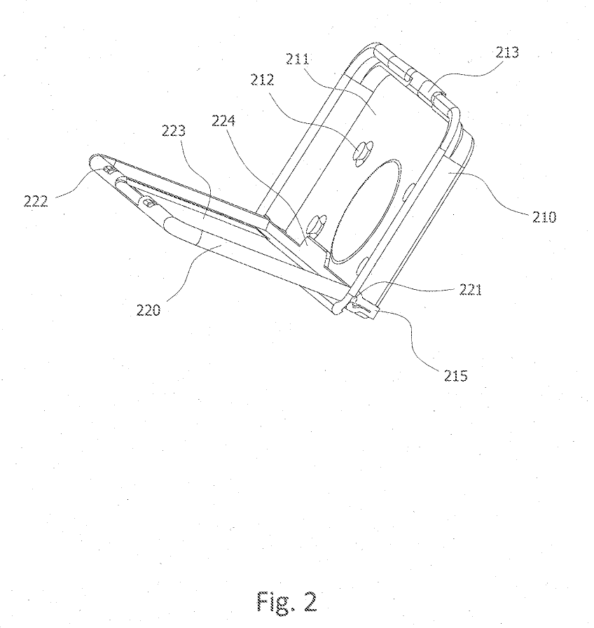

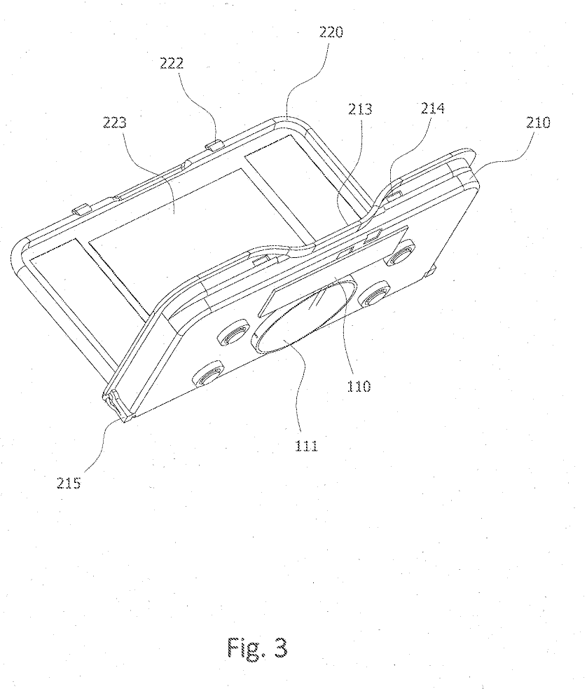

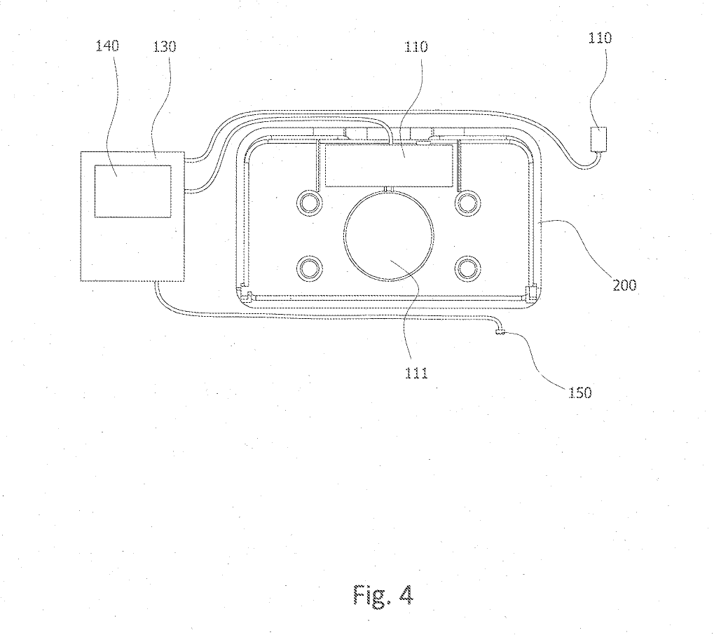

Referring to FIG. 1-4, a sun visor with wireless charging comprises a sun visor body (100) having a charger stand (200) therein; a wireless charging circuit module (110) disposed inside the sun visor body (100), said wireless charging circuit module (110) including a coil (111) coupled to the charger stand (200); wherein said charger stand (200) comprises a case (210) and a cover (220) mounted on said case (210), wherein the case (210) includes a containing space (211) having washers (212) therein; wherein the washers (212) are elastic sucker structures for positioning an electronic product as being covered by the cover (220), which prevent slippage of the electronic product when driving on a bumpy road, simultaneously, by adopting the washer (212) structure, the containing space (211) can efficiently improve the fitness, so as to receive different sizes of the electronic product and improve the versatility of the charger stand (200).

The washers (212) are spaced on a bottom wall of the containing space (211); by sucking a plurality of parts of the electronic product, the electronic product is more stable inside the containing space (211).

A side wall of the case (210) is proviced with a concave part (213) and fastener slots (214) positioned in two side of the concave part (213); a pivotal connection between the case (210) and the cover (220) is provided with an resilient arm (215); a place in the cover (220) coupled to the resilient arm (215) further proviced with a rotation axis (221) which are stuck in the resilient arm (215), wherein the cover (220) is arranged around the resilient arm (215) via the rotation axis (221); wherein a place in the cover (220) coupled to the fastener slots (214) is provided with fasteners (222), wherein the fasteners (222) are disposed inside the fastener slots (214), which makes the cover (220) fixed tightly with the case (210) to prevent the electronic product from falling out of the fastener slots (214) when driving in bumpy road.

The concave part (213) facilitates the cover opening from the fastener slots (214), wherein the resilient arm (215) is used to limit resilience of the rotation axis (221), so as to facilitate opening the cover (220) from the fastener slots (214) by the deformation of the resilient arm (215).

In one of embodiments, wherein a middle part of the cover (220) is provided with a transparent window (223), so users can watch clearly the charging process of electronic product through the transparent window (223);

In one of embodiments, wherein one end of pivotal connection between the cover (220) and the case (210) is provided with a positioning convex piece (224) which is used to support the electronic productand limit its position, thereby effectively guaranteeing the connection between the coil (111) of the wireless charging circuit module (110) and a receiving coil of the electronic product; as the cover (220) and the case (210) are closed, the electronic product is fixed tightly in the containing space (211) to avoid moving when driving on bumpy road.

In one of embodiments, wherein the sun visor body (100) is further provided with a power interface (120) which is electrically connected with the wireless charging circuit module (110), a car power source being provided to the wireless charging circuit module (110) by the power interface (120); wherein the sun visor body (100) is further provided with a bluetooth module (130) for electronic products and bluetooth connection, a radio frequency module (140) for transmitting audio signal from an electronic product to a vehicle stereo, and a microphone (150) for electrically connected with the bluetooth module (130) that a signal is being transmitted to electronic product through the bluetooth module (130) to realize communication function.

In one of embodiments, wherein the sun visor body (100) is provided with a keypad module (160) arranged in one side of the charger stand (200); the keypad module (160) electrically connected with the bluetooth module (130) and controlled the electronic product via the bluetooth module (130), whereby the function of the volume and playlists of electronic product is being adjusted.

In the beginning of using the present invention, fix an electronic procuct in the cover (220) by the positioning convex piece (224) and close the cover (220), now the fasteners (222) being disposed inside the fastener slots (214), the cover (220) being fixed tightly in the case (210); a screen of the electronic product faced to the transparent window (223) of the cover (220), so as to facilitate monitoring the charging process; when the electronic product need to take out, put a finger in the concave part (213) to open the cover (220); At this point, the clips separate from the clip slots, the cover (220) pivot with the resilient arm (215) to take out of the electronic product.

By connecting between the bluetooth module (130) and the electronic product, the electronic product can answer automatically an incoming call and talk with microphone (150); moreover, by adopting the radio frequency module (140), an audio signal of the electronic product being transmitted to vehicle stereo to play the music with speakers.

It will be evident to those skilled in the art that the invention is not limited to the details of the foregoing illustrated embodiments and that the present invention may be embodied in other specific forms without departing from the spirit or essential attributes thereof. The present embodiments are therefore to be considered in all respects as illustrative and not restrictive, the scope of the invention being indicated by the appended claims rather than by the foregoing description, and all changes which come within the meaning and range of equivalency of the claims are therefore intended to be embraced therein.

I claim:

1. A sun visor with a wireless charging function comprising a sun visor body (100) having a charger stand (200) therein; a wireless charging circuit module (110) disposed inside the sun visor body (100), said wireless charging circuit module (110) inducing a coil (111) coupled to the charger stand (200); wherein said charger stand (200) comprises a case (210) and a cover (220) mounted on said case (210), wherein the case (210) includes a containing space (211) having washers (212) therein.

2. The sun visor with a wireless charging function of claim 1, wherein said cover (220) is disposed right above the case (210), and a pivotal connection between the case (210) and the cover (220) is provided with an elastic arm (215); the cover (220) coupled to the elastic arm (215) at which a rotation axis (221) is arranged and is stuck within the elastic arm (215), the cover (220) revolved around the elastic arm (215) via the rotation axis (221).

3. The sun visor with a wireless charging function of claim 1, wherein one end of pivotal connection between the cover (220) and the case (210) is provided with a positioning convex piece (224).

4. The sun visor with a wireless charging function of any one of claim 1-3, wherein one end of a side wall of the case (210) is provided with a concave part (213), and the case (210) disposed two side of said concave part is provided with fastener slots (214); wherein the cover (220) coupled to the fastener slots (214) at which fasteners (222) are disposed, the fasteners (222) are disposed inside the fastener slots (214).

5. The sun visor with a wireless charging function of any one of claim 1-3, wherein a central part of the cover (220) includes a transparent window (223).

6. The sun visor with a wireless charging function of any one of claim 1-3, wherein the washers (212) are elastic sucker structures.

7. The sun visor with a wireless charging function of any one of claim 1-3 wherein the washers (212) are disposed at intervals on a bottom surface of the containing space (211).

8. The sun visor with a wireless charging function of any one of claim 1-3, wherein the sun visor body (100) is further provided with a power interface (120) which is electrically connected with the wireless charging circuit module (110).

9. The sun visor with a wireless charging function of any one of claim 1-3, wherein the sun visor body (100) is further provided with a bluetooth module (130) for connecting with electronic products through bluetooth, a radio frequency module (140) for transmitting audio signal from an electronic product to a vehicle host, and a microphone (150) being electrically connected with the bluetooth module (130), used for transmitting signal to electronic product through the bluetooth module (130) to realize communication function.

10. The sun visor with a wireless charging function of claim 9, wherein the sun visor body (100) positioned in one side of the charger stand (200) includes a keypad module (160); the keypad module (160) electrically connected with the bluetooth module (130) and controlled the electronic product through the bluetooth module (130).
